(19) United States
(12) Patent Application Publication
(10) Pub. No.: US 2006/0253260 A1
(43) Pub. Date: Nov. 9, 2006

(54) Methods for establishing and analyzing the conformation of amino acid sequences

(76) Inventors: Gerald Boehm, Halle (Saale) (DE); Roman Dalluege, Halle (DE)

Correspondence Address: JENKINS, WILSON, TAYLOR & HUNT, P. A., 3100 TOWER BLVD, SUITE 1200, DURHAM, NC, 27707, US

(21) Appl. No.: 11/370,582

(22) Filed: Mar. 8, 2006

Related U.S. Application Data
(63) Continuation of application No. PCT/EP04/10024, filed on Sep. 8, 2004.

(30) Foreign Application Priority Data
Sep. 8, 2003 (EP) 03020301.2

(51) Int. Cl. G06F 19/00

(52) U.S. Cl. 702/19

(57) ABSTRACT

The present invention relates to methods for establishing and analyzing the conformation of amino acid sequences. In particular, the invention relates to methods for the validation of the conformation of given amino acid-based molecules, methods for conformation determination starting from a linear amino acid sequence as well as methods for the alignment of two or more amino acid sequences.

### RELATED APPLICATIONS

This application is a continuation of PCT International Patent Application No. PCT/EP2004/010024, filed Sep. 8, 2004, which claims priority to European Patent Application No. 03020301.2, filed Sep. 8, 2003, the disclosures of each of which are incorporated herein by reference in their entitety.

The present invention relates to methods for establishing and analyzing the conformation of amino acid sequences. In particular, the invention relates to methods for the validation of the conformation of given amino acid-based molecules, methods for conformation determination starting from a linear amino acid sequence as well as methods for the alignment of two or more amino acid sequences.

An important task of molecular bioinformatics is the organisation of the complex and large data quantities of the biological sciences and also the discovery of novel informational relationships in the sense of a data mining. In many cases, the information obtained by gene sequencing can be only utilized practically if the functional role of a particular (gene) sequence has been discovered. However, in the context of modern biotechnology gene sequences have only a limited informational value while the expressed proteins play a central role for biological functions. In recent years, a high-quality data base of the human genome sequence and of other important genomes has been provided, and since then it will the next big step in research to determine important biological functions of the components of the cellular proteome. In this respect, the present invention can be an important and valuable help in predicting the tertiary structure of proteins by means of the sequence, comparing two amino acid sequences by the preparation of alignments as well as validating given protein structures.

The key for the important understanding of the biological and functional properties of proteins ultimately rests in their precise, unequivocal three-dimensional structure (conformation); in the following, the two terms “conformation” and “three-dimensional structure” will be used synonymously. Life Sciences companies need such biological properties for example for the assessment and optimisation of experimental work, and for the finding of novel functions and properties of proteins. A computerized method for modeling the structure can be performed quickly and cost-effectively, it can be carried out in the absence of material (the preparation of which can be laborious), and it can often accurately demonstrate essential properties of the target protein examined even before the strenuous experimental elucidation of its structure. Die determination of such structural models therefore forms an important part of modern molecular bioinformatics; the folding problem, i.e. the prediction of the tertiary structure of proteins on the basis of sequence information, is considered to be the key discipline in bioinformatics today. To date, it has not been understood which mechanism underlies the folding of a given amino acid sequence into a native and functional protein tertiary structure, and thus there does not exist any unequivocal mathematical algorithm to derive the tertiary structure on the basis of sequence information. In this context, the present invention enables the determination of a reliable model structure of proteins as well as the validation (evaluation of the reliability) of structures. Furthermore, proteins ca be altered by artificially introduced point mutations designed to affect the properties of the proteins; the choice of such point mutations can be performed in a more rational way on the basis of the present invention than by means of the criteria used so far.

The prediction of the tertiary structure of proteins is mainly based on knowledge-based approaches which at the moment are considered to be the most reliable procedures for structure prognosis (Böhm, Biophys. Chem. 59, 1-32, 1996). For this purpose, knowing the sequence of an unknown protein and a template structure “related” thereto it is attempted to deduce a tertiary structure model by means of comparative modeling (homology modeling). However, a so far unknown folding topology cannot be predicted by this method; but it is expected that until approximately the year 2010 in the frame of the “structural genomics” initiative all relevant natural topologies will be known. After this date, completely novel protein topologies are only very rarely expected (Berman et al., Nature Struct. Biol. 7, 957-959, 2000). The typically employed methods of comparative modeling are relatively robust and reliable from a certain degree of relationship on—approximately 50% sequence identity of unknown protein and template (Hilbert et al., Proteins: Struct. Funct. Genet. 7, 138-151, 1993)—but even then they can determine details such as for example differences in the electrodynamics of the active core of a protein only with a limited resolution. Therefore, it is very important to determine for every tertiary structure model additionally also the reliability thereof in order to exclude an over-interpretation of the models. Today, several commercial and non-commercial methods and algorithms are available for comparative modeling.

Basically, a modeling can be performed according to the following steps:
Identification of related proteins by comparison based on the sequence (sequence homologies) or by other methods (e.g. threading)
Alignment of the sequences of unknown protein and parental structures; as many (different) parental structures as possible of a common folding topology should be involved. This alignment is the critical step in modeling and is assisted by the present invention
Identification of structurally conserved and variable regions (protein core and loops)
Deduction of the coordinates of the protein core (structurally conserved areas, in particular in the regions with periodical areas of secondary structure) by known methods and procedures
Prediction of the conformation of the loops (structurally variable areas) including the modeling of insertions and deletions in these segments; also for this a plurality of technical methods has been established
Validation of the model structure and quality analysis, optionally also geometric refining of the model structure. This final step is again assisted by the present invention.

The knowledge of the spatial structure of proteins is an essential requirement for the recognition of cell biological relationships and functions, of regulatory mechanisms and enzymatic catalysis, the interpretation of in vitro experiments and the rational design of antibiotics, vaccines, and other active agents in molecular medicine. The limiting step for experimental determination on the basis of the X-ray structural analysis is the crystallisation under conditions suitable to obtain high-resolution structural data; in the case of multi-dimensional NMR the molecular size of the resolvable structure is limited although it is constantly pushed to higher limits. In any case, the material requirement for experimental structure elucidations is enormous, and success is often not guaranteed. In contrast, the sequence of proteins (on the basis of gene sequences) can generally be determined quickly and with relatively small effort. Therefore, the number of gene and protein sequences available today is increasing much faster than the number of known structures.

A further significant scientific progress, predominantly in the medical area and in the area of cell biological research, requires an as effective solution of the folding problem as possible. Besides, if reliable tools for structure calculation on biological macromolecules were used, for example, also the number of essential animal experiments for the development of novel pharmaceutics could be dramatically decreased by simulating potential medicaments by means of computer programmes with regard to their biological action.

One of the most fundamental efforts in the area of molecular structure calculation is the prognosis of the secondary structures on the basis of the amino acid sequence. This is focused on the idea that the folding of the secondary structures into a three-dimensional model can be much easier performed in a combinatory manner once a correct secondary structure prognosis has been made compared to an ab initio prognosis of the structure. A recent comparison of the different, currently published methods for secondary structure prediction can be found in the work by McGuffin & Jones, Proteins: Struct. Funct. Genet. Vol. 52, pp. 166-175, 2003.

Die original method according to Chou and Fasman is based on the frequency distribution of amino acids in secondary structure elements in known protein structures. Following the establishment of conformational parameters for all 20 natural amino acids the target sequence is searched for nucleation centres of four to six amino acids in length which can function as initiators for the respective secondary structure type. The Chou/Fasman method with a mean predictivity of 57% is considered to be a less successful method; obviously the examination of each amino acid individually is not applicable as a predictive measure. In contrast, the present invention uses information obtained from oligopeptides, i.e. short amino acid segments of two or more amino acids in length. Die GOR method (according to Garnier, Osguthorpe and Robson, the authors of the first publication; Gamier et al., J. Mol. Biol. Vol. 120, pp. 97-120, 1978) extends the Chou/Fasman method by a logarithmic information function for each type of secondary structure. It selects that conformation as the most probable which shows the greatest difference between that and the other two secondary structure types. In this case, a mean predictivity of 63% can be expected.

The methods mentioned above can be improved by taking into account sequence homologies to known structures; in this case the mean predictivity will be approximately 88%. Neuronal networks achieve a mean predictivity of 64% if used once and also of approximately 88% of correct predictivity if also homologous sequences are taken into account. Other methods attempt to join the different methods in the form of a “joint prediction” in order to improve the precision. It has been concluded from the up to now still limited predictivity that the unpredictable action-at-a-distance interactions determine the local conformation to approximately 20 to 30% (Kabsch & Sander, Biopolymers Vol. 22, pp. 2577-2637, 1983); however, this has been moderated later by showing that primarily the limited size of the underlying protein data base is responsible for the limitation of the methods (Rooman & Wodak, Nature Vol. 335, pp. 45-49, 1988). In summary, the secondary structure prediction based on the methods known to date is principally limited and often unreliable. Therefore, the present invention goes beyond a mere secondary structure prognosis.

It is a generally appreciated fact that the molecular energy of a system, i.e. the sum of all interactions between protein and surrounding solvent, determines the formation of a long-term stable structure, the so-called native state (Anfinsen & Scheraga, Adv. Protein Chem. Vol. 29, pp. 205-300, 1975; Jaenicke, Prog. Biophys. Mol. Biol. Vol. 49, pp. 117-237, 1987). This abstract term can first be described as a thermodynamic mixture of conformations fluctuating (as in all dynamic systems) around a reference conformation. A tertiary structure determination can generally be considered as successful if the reference conformation is accurately determined; “substates” and the dynamically generated mixtures which may be important for function (e.g. for the stabilisation of intermediates and transition states) will not be considered further at this point.

Thus, the search for the so-called folding code (Jaenicke, Naturwissenschaften, Vol. 75, pp. 604-610, 1988) would primarily be the problem of providing a complete energy function for the entire system enabling a precise differentiation between the native state and all other (denatured) states which are not favoured under native conditions. It is sometimes stated that due to the extremely large number of non-native conformations an empirical search for the native conformation cannot be performed by means of computers since even the fastest of the computers available at the moment are far unable to cope with such a search. This is a technical problem which shall not be considered further at this point. The energy function mentioned above is not available at the moment. Current attempts of an ab initio tertiary structure prognosis are often conducted according to the following general scheme (Hardin et al., Curr. Opin. Struct. Biol., Vol. 12, pp. 176-181, 2002):
Determination of the secondary structure to be expected using conventional methods for secondary structure prognosis (McGuffin & Jones, see above);
Determination of a preliminary tertiary structure by calculating an optimal packing of the secondary structure elements;
Refining the structure by using empirical potential functions and/or methods based on pattern recognition of analogous procedures.

Up to now, no result has been published in the literature which is able to show a promising way for an ab initio tertiary structure prognosis. In this regard, it can also be doubted whether this method represents a principally practicable way for structure predictions even under the aspect that generally only a limited accuracy of the structure is expected. The required hierarchical order of secondary structure elements which are independently folded initially and associate with each other afterwards finds only very limited support in experimental findings.

As discussed above, due to the inability to make a correct ab initio tertiary structure prognosis the discussion focuses at the moment on knowledge-based methods for structure prediction. For these, the availability of a parental structure, i.e., the structure of a homologous protein (optionally also with the same function) and with a suspected evolutionary relationship to the protein examined is a prerequisite. Besides, it should be understood that also the sequence of the protein to be modelled is required. The method has been successfully used in many cases to at least obtain model concepts about structural and functional properties of novel proteins which could give rise to suggestions for experimental examinations in the following. In this respect, the technical process of modeling is a largely solved technical problem today; however, it is critical for modeling that the two informations (unknown protein and template structure(s)) are principally correctly aligned and that the resulting model structure is afterwards evaluated as to its accuracy. Both of these essential aspects of structure prognosis of proteins by means of comparative modeling are supported by the present invention.

The primary step which forms a start to comparative modeling (besides an appropriate literature search for known experimental examinations of structure, function and mechanisms of action) is the determination of a reliable sequence. Any error in the determination of the primary structure will subsequently give rise to errors with respect to the structure which in the best case only relate to local interactions but in the worst case may result in a (locally) erroneous alignment and thus generally in a useless model. It is estimated that up to 20% of the protein and gene sequences present in data bases are at least partially incorrect.

In the next step, an alignment is prepared which comprises at least the sequence to be modelled and the parental protein. Various standard methods exist for the preparation of alignments; besides an alignment in pairs (2 sequences) there exist also algorithms for a multiple alignment (with more than 2 sequences). The alignment is an optimal correlation (in pairs) of amino acid positions with the aim of generating a minimum of defects (substitutions, insertion or deletion—“InDel”—of amino acids) and a maximum of consistencies. In this case, the evaluation of the significance of defects is a variable factor which can lead to different alignments. The introduction of different evaluation parameters, such as evolutionary contexts of substitutions, hydropathic or geometric properties, degeneration of the genetic code, structural information on the parental molecule and so on can influence the success of alignments (in a positive as well as in a negative manner). The alignment is the critical step in modeling; therefore, the following Examples of the invention provide different situations in the determination of alignments by using the invention.

Following the identification of the structurally conserved regions on the basis of the alignment the process of modeling itself is carried out. For this purpose, the amino acids differing from each other in the sequence are replaced at the respective positions in the parental structure for which the following criteria are typical: (1) in the case of a substitution all possible binding angles of the original amino acid are maintained as much as possible; (2) overlapping van der Waals contacts of atoms are to be avoided as much as possible; (3) in the later refining process using molecular dynamic or energy-functional methods conserved groups present at identical positions in the parental molecule and in the model should be secured, and only substituted or newly added groups should be subsequently moved spatially if possible. Besides, this boundary condition is not derived from empirical examinations but arose from the expectation that it could be useful in the simulation of evolutionary processes.

Additional attention requires the modeling of turns and loop regions carrying insertions or deletions (per definitionem insertions and deletions can never occur within periodical secondary structure elements such as helix and β sheet but only at their boundaries or in the connecting loops). Several methods exist for a novel determination of the spatial course of these loops: (1) data base search wherein an optimal geometry for the loop is extracted from a given structural data set on the basis of known structures; (2) conformational search for loops which fulfil the criteria required for loop regions in an energetically and geometrically optimal way. Conformational search can be performed for example by Monte Carlo methods or by using high-temperature molecular dynamics simulations.

At the end of the structure forming process there are typically carried out refining methods to improve the geometry and energy content of the novel molecule. These methods themselves comprise protocols for molecular dynamics simulation and also the application of energy potential functions. However, it has sometimes been observed that such refined structures result in a relatively more incorrect conformation of the model as compared to the starting structure. Thus, refining methods should be used carefully and prudently.

Eventually, an evaluation of the reliability of the model should be carried out. To date, useful tools for this are scarcely available (Novotny et al., Proteins, Vol. 4, pp. 19-30, 1988; Bowie et al., Science, Vol. 253, pp. 164-170, 1991). A critical evaluation of the model is required in any case; only in rare cases a model can be expected to be able to reproduce functional aspects up to an atomic resolution in contrast to experimentally determined structures. Therefore, in the analysis of the novel suggestions implicated by the model it has to be kept in mind that every model principally does only permit conclusions of a limited resolution. The method described by this invention is excellently suitable to perform a validation or an evaluation, respectively, of the predicted structure.

Therefore, the object underlying the present invention is to provide improved methods for conformation determination and conformation analysis of amino acid sequences.

These objects have been achieved by the subject matter of the independent claims. Preferred embodiments of the invention are stated in the dependent claims.

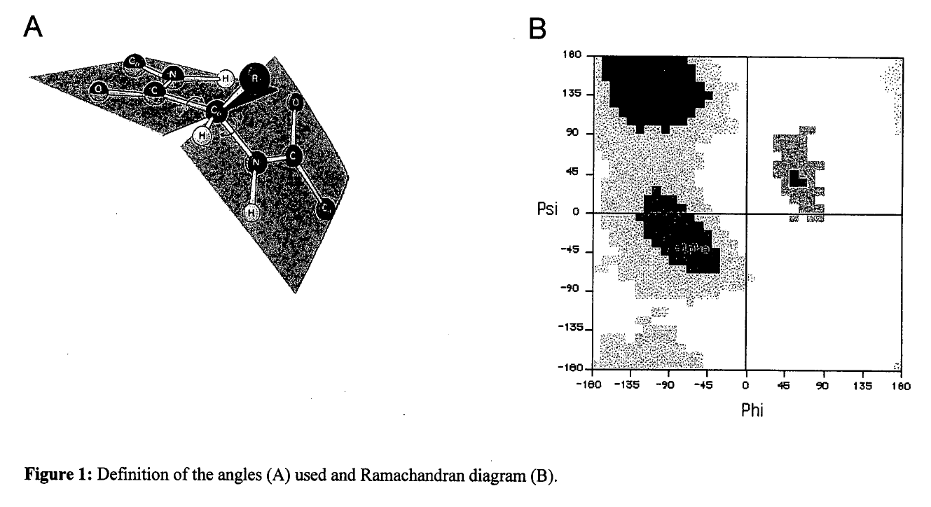

The present invention describes method which enables both the calculation of conformations of amino acid chains and the validation of given structures. For this purpose, a data base of information is generated first which is built from short segments (oligopeptides) of known protein structures. Preferably, but not exclusively, tetrapeptides (four amino acids directly succeeding each other in the sequence) are used for this purpose. Out of this structural information obtained from these tetrapeptides the back bone angles (phi/psi angles; FIG. 1A) between the second and the third amino acid of the tetrapeptide are used. These two angles are input into a data base as the typical signature of the corresponding tetrapeptide and are evaluated statistically therein as further detailed in the Examples below.

The present invention relates to the following aspects and embodiments:

According to first aspect the invention relates to a method for the validation of the conformation of given amino acid-based molecules comprising the following steps:
a) dividing the amino acid-based molecule into oligopeptides of the same length wherein the number of the oligopeptides is preferably defined by the formula:
   n−(m−1)
in which n is the number of amino acids in the amino acid-based molecule and m is the number of amino acids in the oligopeptide, and determining the psi and phi angles of all oligopeptides present in the given amino acid-based molecule (observed value);
b) providing or preparing an oligopeptide data base which contains the values for the phi and psi angles for these oligopeptides;
c) determining the psi and phi angles for each of the oligopeptides determined in a) from the data base information (expected value);
d) subtracting the expected value from the observed value;
e) evaluation of the differences for each amino acid position wherein the smaller the difference between the expected value and the observed value is the higher is the probability of the accuracy of the given structure.

Thus, the method described above means that an amino acid-based molecule is first divided into oligopeptides of the same length according to the following procedure: if for example a molecule having 200 amino acid residues shall be divided up into oligopeptides of each 4 amino acid residues in length (m=4) the total number of the resulting oligopeptides will be: 200-(4-1)=197. In view of the amino acid-based molecule the oligopeptides will be generated in the order: 1,2,3,4; 2,3,4,5; 3,4,5,6; etc. wherein the number in each case represents the amino acid position in the amino acid-based molecule.

The invention comprises a division into oligopeptides which preferably are 2-10 amino acids in length but wherein tetra- and pentapeptides are preferred. As the amino acid-based molecules in the sense,of the present invention all conceivable amino acid-based structures are considered: polypeptides having an amino acid length of approx. 10-100 amino acids, proteins having an amino acid length of more than 100 amino acids, etc. There are no restrictions with respect to the total length of the amino acid-based structures to be examined. Similarly, the methods according to the present invention can not only be applied to natural proteins but for example also to proteins which have been altered by chemical or enzymatic modification.

Thus, also modified proteins can be analysed which have undergone for example alterations in the chemical structure of their side chains by phosphorylation, biotinylation, deamidation, or by other chemical procedures. Besides chemical alterations, proteins can also be analysed by using non-proteinogenic amino acids (i.e. such amino acids which do not belong to the standard repertoire of the 20 amino acid types used in nature), for example in the frame of a full chemical synthesis or in the cell-free preparation of proteins (in vitro translation).

According to a preferred embodiment, the expected value is the maximum of the probability density function of the psi and phi angles determined in c) and the observed value represents the psi/phi values observed for each oligopeptide in a). With respect to the calculation of this value reference is made to the following description.

It shall be pointed out that principally any other method of probability theory and statistics can be used instead of the probability density function. These are methods known to those skilled in the art and can be found for example in the textbook by Ulrich Krengel, “Einführung in die Wahrscheinlichkeitstheorie and Statistik” (7^{th} revised edition 2003. Vieweg Verlag, ISBN 3-528-57259-0).

In one embodiment of the invention, in step c) the expected value is determined for oligopeptides in which one or more amino acids or sequence segments of a certain length are substituted or altered, respectively, compared to the oligopeptides present in the given amino acid-based molecule in the form of a similarity rule wherein the amount of the difference between observed value and expected value is a measure for the conformational change to be expected by the substitution.

By using this method it is for example possible to substitute an amino acid present at a particular position in the given amino acid-based molecule by another one wherein the expected value is then directed to a sequence with an altered amino acid. As an example, a substitution of Ala by Cys can be contemplated. The amount of the difference between observed value and expected value then will provide a direct indication as to how the amino acid substitution affects the conformation of the whole molecule. This principle can also be used for the validation of insertions and deletions besides amino acid substitutions.

According to another aspect, the present invention relates to a method for conformation determination starting from a linear amino acid sequence comprising the following steps:
a) dividing the amino acid sequence into oligopeptides of the same length wherein the number of the oligopeptides is defined by the formula:
   n−(m−1)
in which n is the number of amino acids in the amino acid-based molecule and m is die number of amino acids in the oligopeptide;
b) providing or preparing an oligopeptide data base which contains the values of the phi and psi angles for these oligopeptides;
c) determining the psi and phi angles for each oligopeptide determined in a) from the data base information;
d) generating the conformation of the amino acid sequence from the psi and phi angles determined in c) for each oligopeptide.

The conformation of the molecule can be for example generated by computerized methods.

According to a preferred embodiment, the value of each of the psi and phi angles determined in c) is defined by the maximum of the probability density function of the psi and phi angles of each phi and psi angle provided in b).

According to a third aspect, the invention relates to a method for the alignment of two or more amino acid sequences comprising the following steps:
a) providing an amino acid-based molecule having an unknown conformation and one or more template sequences;
b) dividing the two or more template sequences and the amino acid-based molecule having an unknown conformation into oligopeptides of the same length wherein the number of the oligopeptides is defined by the formula:
   n−(m−1)
in which n is the number of amino acids in the amino acid-based molecule and m is the number of amino acids in the oligopeptide,
c) determining the psi and phi angles of preferably all oligopeptides present in the template sequence(s);
d) providing or preparing an oligopeptide data base which contains the values of the phi and psi angles for the oligopeptides from b) and c);
e) alignment of the amino acid sequences on the basis of the comparison of the expected values of the psi and phi angles for the amino acid-based molecule having an unknown conformation and the observed psi and phi angles of the one or more template sequences.

According to a preferred embodiment, the value of each psi and phi angle used in e) is defined by the maximum of the probability density function of the psi and phi angles of each phi and psi angle provided in d) for these oligopeptides.

As already mentioned above, oligopeptides consisting of five amino acids (pentapeptides) are preferably employed according to the present invention.

For this purpose, the psi and phi angles are preferably measured between the second and the third as well as the third and the fourth amino acid of the pentapeptide.

Particularly preferred, however, is the embodiment in which the oligopeptides each consist of four amino acids (tetrapeptides). Thus, according to the formula n−(m−1) given above the number of the tetrapeptides is n−3. In this case, the psi and phi angles between the second and third amino acid of the tetrapeptide are preferably measured.

According to the invention, the method of validation described above can be particularly used in an evaluation of the amino acid-based molecule with respect to particular properties by comparing the observed value and the expected value.

Those angles in the phi and the psi regions which are often used by amino acids in protein structures are summarized in the so-called Ramachandran diagram which is exemplarily shown in FIG. 1B. This information from the Ramachandran diagram is initially insufficient for a conformation determination and conformation analysis since principally all (“allowed”) binding angles between two amino acids occurring in the Ramachandran diagram can be considered as relevant for structure.

It is now the principal novelty of the present invention that the dihedral angels between two particularly identified amino acids are categorized in relationship to their neighbouring amino acids. If for example oligopeptides of four amino acids are used, a large collection of tetrapeptides (“1234”) is obtained in this manner for which the spatial structure can be correlated with the psi and phi angles between the central amino acids 2 and 3. In this regard, a statistical analysis of the results is performed by means of the method of non-parametric kernel density estimation (KDE) which is known per se.

It is the aim of a kernel density estimation to approximate the probability density function (PDF) ƒ(•) of a random variable X (for n independent observations x₁ . . . xₙ; uni-dimensional case). The kernel density estimator \hat{ƒ}ₕ(x) for the estimation of the density value f(x) of the probability density function at a point x is defined as:

$${\hat{f}}_{h} ( x ) = \frac{1}{nh} {\sum }_{i = 1}^{n} K ( \frac{{x}_{i} - x}{h} ) \qquad ( 1 )$$

K(•) refers to the so-called kernel function, the parameter h is referred to as band width. A number of possible kernel functions exist. Each of them must fulfil the properties of a probability density function, thus:

$${\int }_{- ∞}^{∞} K ( x ) ⅆ x = 1 , K ( x ) \geq 0 \qquad ( 2 )$$

and they generally are symmetrical around zero and unimodal. For the calculations of the probability density function in the present invention the Gauss kernel was used (uni-dimensional case):

$$φ ( x ) = \frac{1}{\sqrt{2 Π}} {ⅇ}^{- \frac{{x}^{2}}{2}} \qquad ( 3 )$$

The aim of multivariate kernel density estimations is to approximate the probability density function f(t)=f(t₁ . . . t_{q}) of the random variable T=(T₁ . . . T_{q})^{T}. For the q-dimensional case the kernel density estimator is defined as:

$${\hat{f}}_{h} ( t ) = \frac{1}{n} {\sum }_{i = 1}^{n} \frac{1}{{h}_{1} … {h}_{q}} K ( \frac{{T}_{i 1} - {t}_{i}}{{h}_{1}} , … , \frac{{T}_{iq} - {t}_{i}}{{h}_{q}} ) \qquad ( 4 )$$

In the present case, two-dimensional kernel density estimators are of main interest since two angles: psi and phi (FIG. 1A) are considered. The two-dimensional kernel density estimator is obtained by multiplying the two univariate kernel functions (one kernel function each for the psi angle and the phi angle).

In the present case, probability density functions of the type y=f(psi, phi) are obtained, i.e., three-dimensional functions defining the probability to observe a particular conformational state of the psi/phi angle between the amino acids 2 and 3 in a given tetrapeptide. The following Examples are based on this evaluation of the tetrapeptide information. This information is calculated in the form of probability density functions for each tetrapeptide individually. This list of probability density functions forms the basis of the other Examples.

A possible application for what is said above can be for example a conformational analysis of a protein. For a novel protein structure (as modelled by the methods described in the introduction or experimentally determined) the psi/phi angles are measured for each tetrapeptide and the functional value of the probability density function for this pair of values is determined. By comparison to the maximum of the probability density function it can be determined how much more improbable the measured angle pair is in comparison to the maximum of the probability density function. For this purpose, both the maximum of the probability density function and the value of the probability density function (for the observed pair of psi/phi values) are logarithmized and subtracted from each other. The difference shows how many orders of magnitude the observed value is more improbable in comparison to the expected value (maximum of the probability density function); in the following Figures this is plotted as the parameter DIFFMAX.

In this manner it is possible to establish an evaluation system by which novel structures can be evaluated.

Another use of probability density functions is to establish a novel alignment method working in an “oligopeptide-wise” manner and not via substitution matrices as in the conventional case. In this way, better results are principally also obtained with respect to an alignment than by conventional methods. Therefore, also the implementation of a method for structure-sequence alignment forms part of the invention which can for example recognize the correct parental structure for a structural modeling better than conventional (matrix-based) methods. The method will be explained below.

Be Q and T sequences with lengths q and t wherein each of the sequences is defined as linear sequence of n symbols of a finite alphabet B:

$$B = \{ \begin{matrix}A = Ala , & C = Cys , & D = Asp , & E = Glu , & F = Phe , \\ G = Gly , & H = His , & I = Ile , & K = Lys , & L = Leu , \\ M = Met , & N = Asn , & P = Pro , & Q = G ln , & R = Arg , \\ S = Ser , & T = Thr , & V = Val , & W = Trp , & Y = Tyr\end{matrix} \} \qquad ( 5 )$$

For every sequence x a setc₄^{x} of all tetrapeptides succeeding each other can be prepared. In present case, this is:
c₄^{Q}=(c_{4,1}^{Q},c_{4,2}^{Q}, . . . c_{4,q-4+1}^{Q}) (6)
and
c₄^{T}=(c_{4,1}^{T},c_{4,2}^{T}, . . . , c_{4,t-4+1}^{T}) (7)

Be PDF₄^{Q} the set of probability density functions corresponding to c₄^{q}:
PDF₄^{Q}=(PDF_{4,1}^{Q}, PDF_{4,2}^{Q} . . . PDF_{4,q-4+1}^{Q}) (8)

Be Ψ₄^{T} and Φ₄^{T} the sets of dihedral angles corresponding to c₄^{T} that have been calculated from the sequence T:
Ψ₄^{T}=(Ψ_{4,1}^{T}, Ψ_{4,2}^{T} . . . Ψ_{4,t-4+1}^{T}) (9)
Φ₄^{T}=(Φ_{4,1}^{T}, Φ_{4,2}^{T} . . . Φ_{4,t-4-1}^{T}) (10)

The principle of the alignment according to the present invention, thus, is the determination of a structure-sequence alignment matrix Mₘₓₙ wherein m=q−4+1 and n=t−4+1. The semi-global alignment is performed according to the conventional Needleman-Wunsch algorithm. The probability density functions which have been newly developed in the context of the present invention were used as scoring functions. Affinic gap penalties according to the Gotoh algorithm were applied.

$$\begin{matrix}σ ( {q}_{i} {t}_{i} ) = \{ \begin{matrix}0 & if 0 \leq σ * ( {q}_{i} {t}_{i} ) < 1 \\ 1 & if 1 \leq σ * ( {q}_{i} {t}_{i} ) < 2 \\ 2 & if 2 \leq σ * ( {q}_{i} {t}_{i} ) < 3 \\ 3 & if 3 \leq σ * ( {q}_{i} {t}_{i} ) < 4 \\ 4 & if 4 \leq σ * ( {q}_{i} {t}_{i} ) < 5 \\ 5 & if 5 \leq σ * ( {q}_{i} {t}_{i} ) < 6 \\ 6 & if σ * ( {q}_{i} {t}_{i} ) = 6\end{matrix} & ( 11 ) \\ σ * ( {q}_{i} {t}_{i} ) log ( \frac{max ( {PDF}_{4 , i}^{Q} )}{{PDF}_{4 , i}^{Q} ( {ϕ}_{4 , i}^{T} , {ψ}_{4 , i}^{T} )} ) & ( 12 ) \\ wherein {q}_{i} = {c}_{4 , i}^{Q} and {t}_{i} = {c}_{4 , i}^{T} & \end{matrix}$$

The following Examples are illustrated and explained in more detail by means of Figures. Generally, the conventional one-letter code is used for the designation of individual amino acid types in the Figures and in the Examples; this code is internationally standardized and must not be explained in more detail.

FIG. 1 shows the definition of the angles as used in the present invention and the angle distribution in the Ramachandran diagram. (A): Schematic representation of a protein bond including the definition of the two angles phi and psi used. This definition can be found in every suitable textbook of protein structure research. (B) Ramachandran diagram for the proteinogenic amino acids with the exception of glycine. The diagram is a typical representation of allowed angles of the two parameters phi and psi.

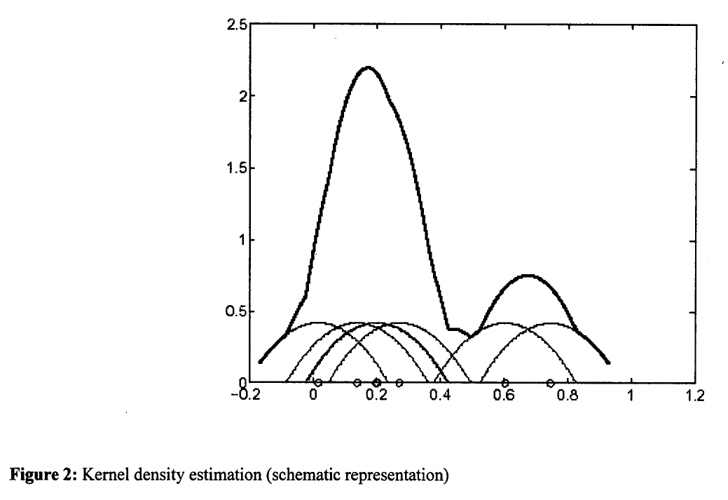

FIG. 2 shows a schematic representation of kernel density estimations.

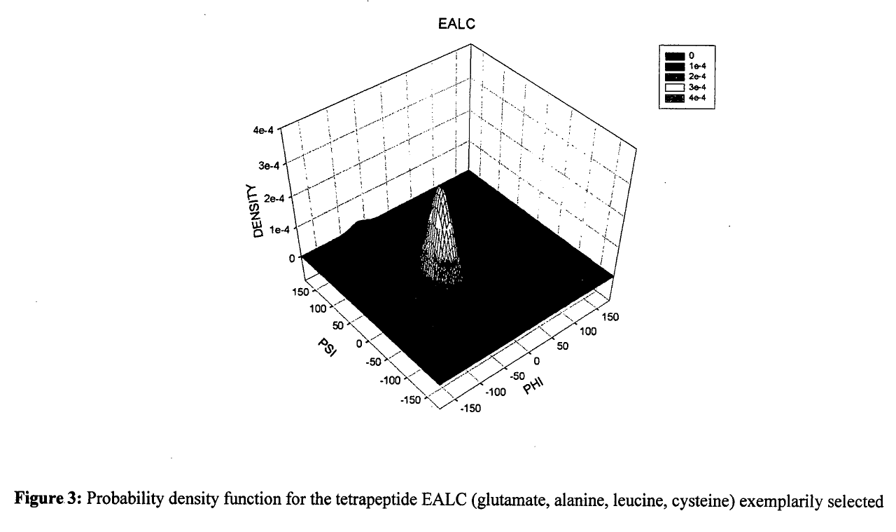

FIG. 3 shows the probability density function for the tetrapeptide EALC (one-letter code; corresponding to the amino acids glutamate, alanine, leucine, cysteine) chosen as an example of a typical result. For the 20 proteinogenic amino acids a total of 20⁴=160.000 different probability density functions are obtained which can be prepared by means of an analysis of the angles observed in natural proteins. The analysis according to the present invention is based on protein structures published in the protein data base (PDB; http://www.rcsb.org).

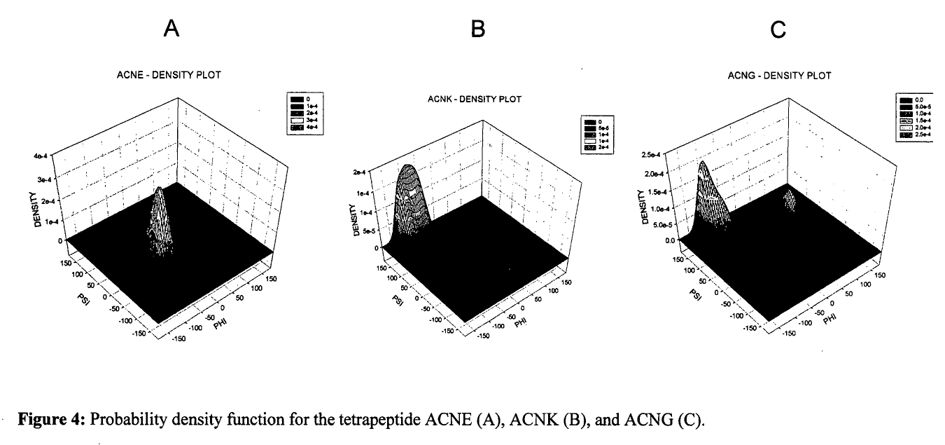

FIG. 4 shows the probability density functions for the tetrapeptides ACNE (A), ACNK (B), and ACNG (C). The fourth amino acid of the tetrapeptide has an essential impact on the density distribution of the phi/psi angles between the second and third amino acid (in each case cysteine/asparagine). The adjacent amino acid can be identified as an important criterion for local structure formation. This Example also shows that the probability density functions represent a suitable evaluation scale for the selection of suitable point mutations in proteins (alteration of individual amino acid positions).

FIG. 5 shows the probability density functions for the tetrapeptides CIDL (A) and CIDV (B). Again, the fourth amino acid of the tetrapeptide has an essential influence on the density distribution of the phi/psi angles between the second and third amino acid. Conventional substitution matrices used for protein design would favour the substitution of the two chemically similar amino acids leucine and valine (fourth position of the tetrapeptide) in this Example. In contrast, the probability density functions show that a structural variation in the tetrapeptide must be expected if the two hydrophobic amino acids leucine and valine are exchanged with each other. It is this type of information which is of particular importance for rational protein design where point mutations of proteins shall be designed; in many cases these point mutations shall allow for limited functional variations while the structure is maintained. This can be assessed by using the probability density functions.

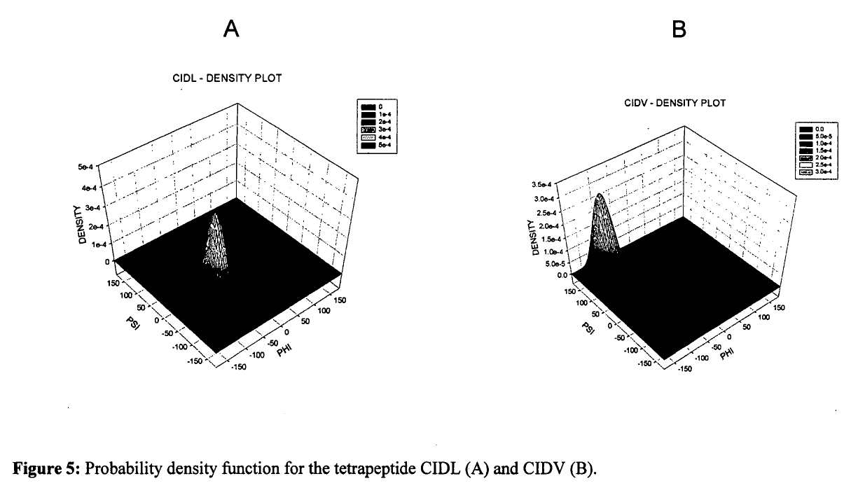

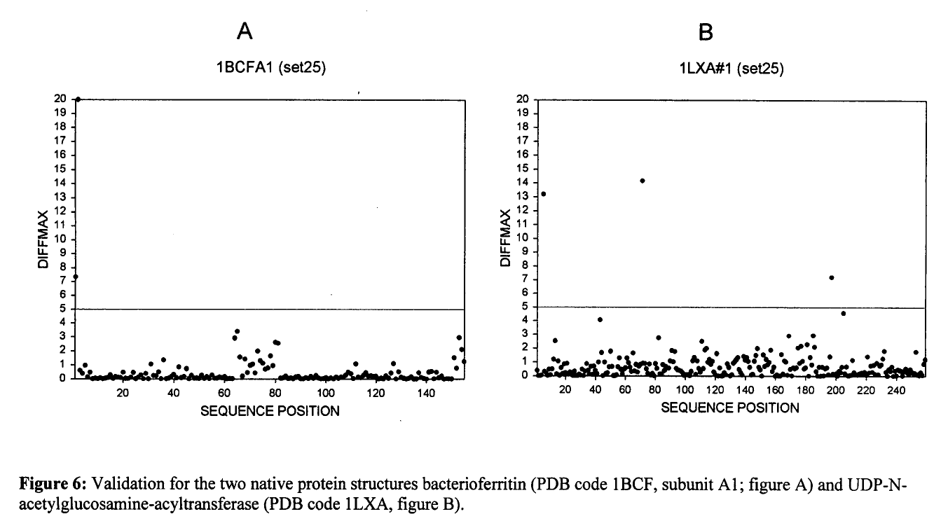

FIG. 6 shows the validation for the two native protein structures bacterioferritin (PDB Code 1BCF, subunit A1; Figure A) and UDP-N-acetylglucosamine acyltransferase (PDB Code 1LXA, Figure B). The evaluations by means of the probability density functions show that the two structures are recognized as native, correctly folded proteins as expected. The DIFFMAX parameter plotted on the ordinate axis reflects the probability that variations of optima derived from the probability density functions can probably be tolerated. Empirically, a limit of 5 (solid red line in FIGS. 6A and 6B) has been obtained as the maximum tolerance. Minor variations from the optimum (zero line of the graph) may be in particular explained by unstructured areas in the proteins.

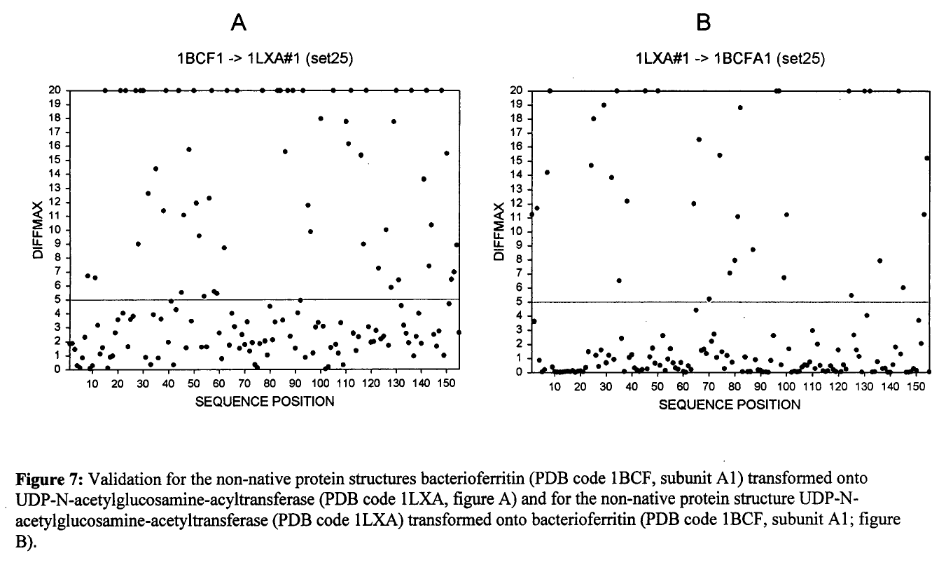

FIG. 7 shows the validation for the non-native protein structure of bacterioferritin (PDB Code 1BCF, subunit A1) transformed onto UDP-N-acetylglucosamine acyltransferase (PDB Code 1LXA; Figure A) and the non-native protein structure of UDP-N-acetylglucosamine acyltransferase (PDB Code 1LXA) transformed onto bacterioferritin (PDB Code 1BCF, subunit A1; Figure B). The evaluations by means of the probability density functions show that the structures are recognized as non-native or incorrectly folded proteins, respectively. The DIFFMAX values in both proteins are unusually often higher than the empirically determined limit of 5 which means that variations from the optimal or the most probable oligopeptide structure, respectively, are found at many position in the protein. In the Figure, values of more than 20 for DIFFMAX were set to a maximum value of 20 for technical reasons.

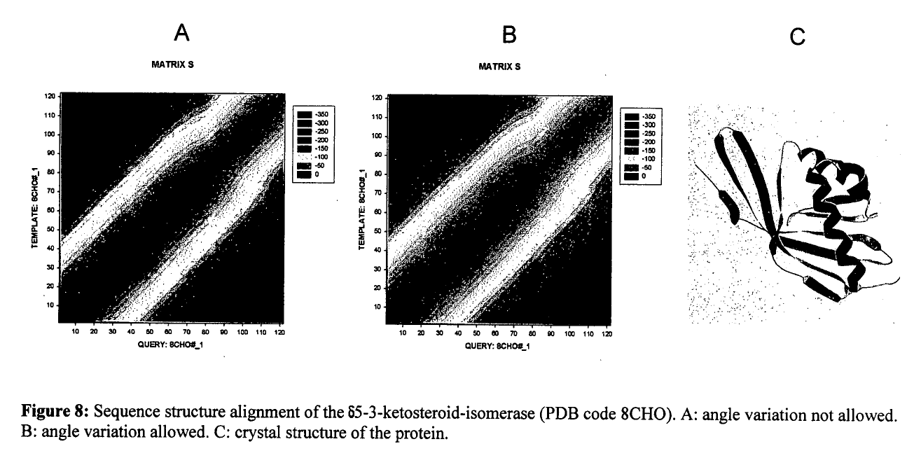

FIG. 8 shows a sequence-structure alignment of the sequence of 65-3-ketosteroid isomerase against its own protein structure (PDB Code 8CHO). The graphic representation of the resulting matrix S shows that it is possible to derive correct information for finding a “path” for the preparation of a correct alignments from the alignment. If a solid red line or a similar area, respectively, is shown in the diagonal of the Figure then the alignment is considered to be successful. In Figure A, the probability density functions do not allow for angle variations. From the matrix R (see equations above) the accumulated score values can be calculated by means of the Needleman-Wunsch algorithm which can afterwards be calculated and graphically represented in the matrix S (A). The probability density functions in B also enable—in contrast to the representation in Figure A—angle variations (B). The crystal structure of the protein is shown in (C). It has been demonstrated that no improvement of the alignment is achieved by allowing angle deviations in this Example.

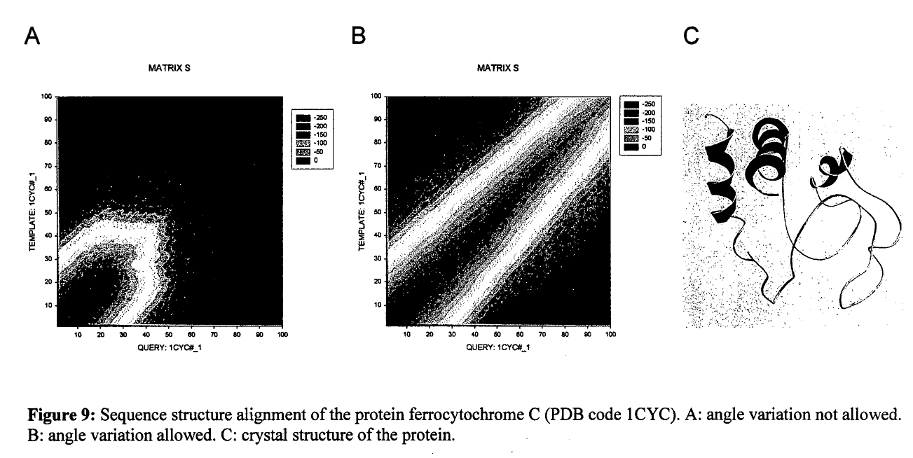

FIG. 9 shows the sequence-structure alignment of ferrocytochrome C against its own protein structure (PDB Code 1CYC). The graphic representation and the method of calculation correspond to the Example shown in FIG. 8. The probability density functions in Figure A do not allow for angle variations. From the matrix R the accumulated score values can be calculated by means of the Needleman-Wunsch algorithm which are represented in the matrix S (A). The probability density functions in B also enable angle variations—in contrast to the representation in Figure A (B). The crystal structure of the protein is shown in (C). It is shown that in this case a complete and correct alignment is made possible by tolerating angle variations in the underlying probability density functions. The reason for the improvement of the method by allowing angle variations in the present Example is that—as shown in Figure C—large portions of ferrocytochrome C consist of less structured loop regions; periodical secondary structure elements (helices) can be found only in very few regions in the structure.

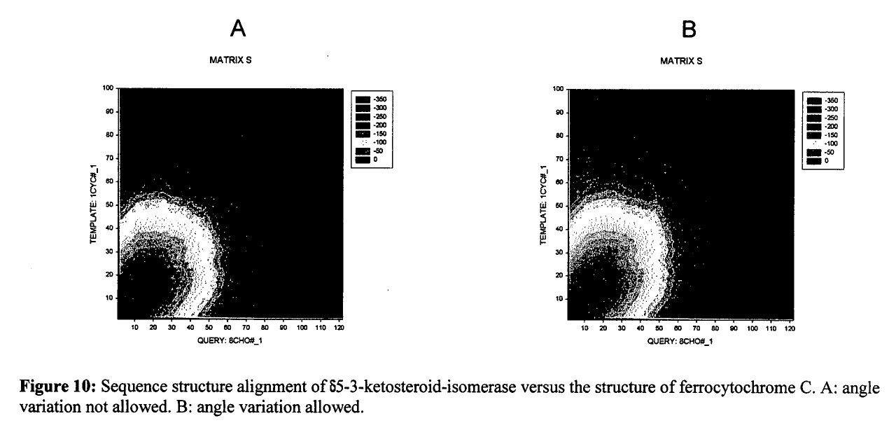

FIG. 10 shows the sequence-structure alignment of δ5-3-ketosteroid isomerase (see also FIG. 8) against the structure of ferrocytochrome C (PDB Code 1CYC; see also FIG. 9). The probability density functions in Figure A do not allow for angle variations. From the matrix R the accumulated score values can be calculated by means of the Needleman-Wunsch algorithm which are represented in the matrix S (A). The probability density functions in B also enable angle deviations—in contrast to the representation in Figure A (B). As expected, the two unrelated sequences and structures cannot be mapped onto each other by means of an alignment; this is independent of the tolerance of angle variations in the underlying probability density functions. This has shown that alignments (with and without tolerance of angle variations in the probability density functions) can be prepared only if there is a structural relationship between the proteins; unrelated proteins are recognized by the method as such, and the alignment method clearly demonstrates that the proteins cannot be aligned with each other.

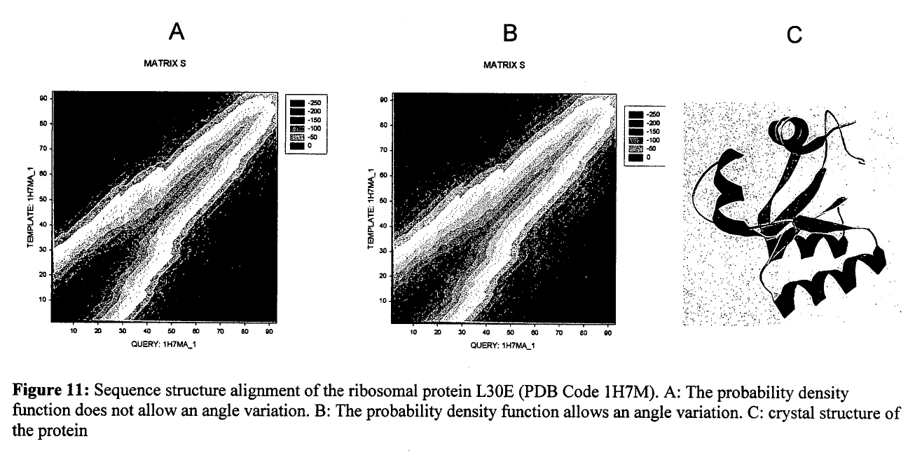

FIG. 11 shows the sequence-structure alignment of ribosomal protein L30E against its own protein structure (PDB Code 1H7M). This protein was one of the target structures in the fifth CASP competition (CASP 5, December 2002). (A) The probability density functions in this case do not allow for angle variations. From the matrix R the accumulated score values can be calculated by means of the Needleman-Wunsch algorithm which are represented in the matrix S. (B) The probability density functions allow angle variations. The Example demonstrates in a retrospective manner that a validation of the method in the last CASP competition would have been principally successful. Furthermore, it is shown that the method can be successfully applied to novel proteins which have not been already deposited in the data base.

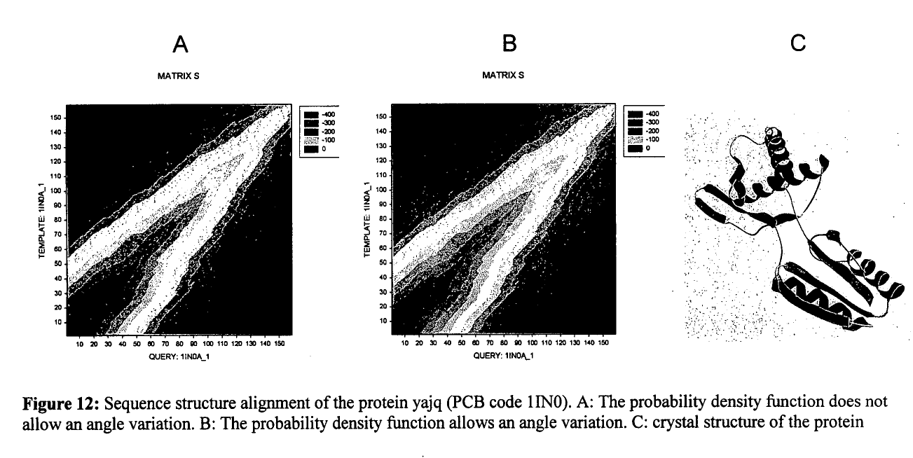

FIG. 12 shows the sequence-structure alignment with the sequence of yajq protein against its own protein structure (PDB Code 1IN0). This protein was one of the target structures in the fifth CASP competition (CASP 5, December 2002). (A) In this Example the data base was used without angle variation. From the matrix R the accumulated score values can be calculated by means of the Needleman-Wunsch algorithm which are represented in the matrix S. (B) The probability density functions allow for angle variations. From the matrix R the accumulated score values can be calculated by means of the Needleman-Wunsch algorithm which are represented in the matrix S. The crystal structure of the protein is represented in (C). As also demonstrated in FIG. 11, this Example shows in a retrospective manner that a validation of the method in the last CASP competition principally would have been successful. Furthermore, it is also shown that the method can be successfully applied to novel proteins which have not been already deposited in the data base.

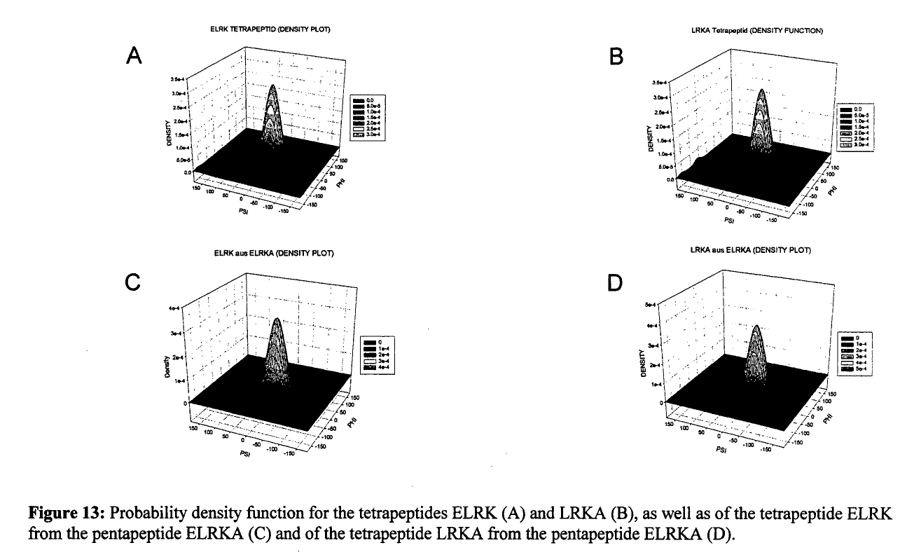

FIG. 13 shows the probability density function for the tetrapeptides ELRK (A) and LRKA (B) as well as for the tetrapeptide ELRK from the pentapeptide ELRKA (C) and the tetrapeptide LRKA from the pentapeptide ELRKA (D). In principle, the method is not limited to tetrapeptides as the underlying oligopeptide unit but can also be performed on the basis of oligonucleotides of different lengths. By using pentapeptide information, in this case by an AND linkage of the respective tetrapeptide information, a novel and also obviously more strict information can be obtained with respect to the angle distributions in the pentapeptide.

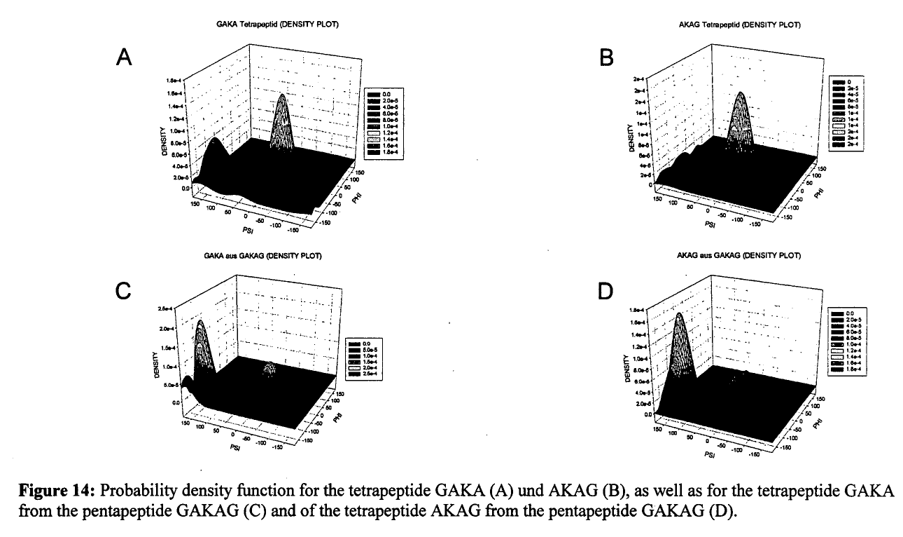

FIG. 14 shows the probability density function for the tetrapeptides GAKA (A) and AKAG (B) as well as for the tetrapeptide GAKA from the pentapeptide GAKAG (C) and the tetrapeptide AKAG from the pentapeptide GAKAG (D).

As already shown in FIG. 13, the information obtained by using oligopeptides of different length is principally comparable to each other but could have an additional information content.

FIG. 15 shows the probability density function for the tetrapeptides VILL (A) and ILLE (B) as well as for the tetrapeptide VILL from the pentapeptide VILLE (C) and the tetrapeptide ILLE from the pentapeptide VILLE (D). The distributions of the angles in the tetrapeptide or in the corresponding pentapeptide, respectively, show interesting correlations which could be utilized as additional information in structure modeling and structure validation.

### EXAMPLE 1

### Preparation of a Conformational Data Base: Determination of Kernel Density Functions

The number of possible tetrapeptides which can be analysed is calculated to 20⁴=160.000 (for 20 proteinogenic amino acids observed in nature; special cases such as selenocysteine will not be separately considered here). To determine the statistical data basis known x-ray crystal structures of proteins were examined in a tetrapeptide-wise manner. For a given protein chain consisting of n amino acids, thus, (n−3) possible tetrapeptides are obtained. For the Examples described below the dihedral angles between the central amino acids of the tetrapeptides were calculated and listed in the form of a table for later statistical analysis.

A prerequisite for the determination of the dihedral angles is that for the psi angle the atoms N(n)-CA(n)-C(n)-N(n+1) and for the phi angle the atoms C(n)-N(n+1)-CA(n+1)-C(n+1) are completely defined (missing atoms are not added to the model); it is not required that the atoms of the two adjacent amino acids are completely resolved. With respect to the quality of the given protein structures selected for the calculation of the probability density functions on the basis of tetrapeptides (see below) the following selection criteria were set up:
the resolution of the protein is better than 3 Å
the R factor for structure elucidation is 2.5 or better; if the R factor is unknown it is set to a value of 2.5.
the protein chain must have at least 30 amino acids; smaller, mostly unstructured peptides are excluded from the conformation analysis.

In the protein structures known to date longer areas can often be found the structure of which is not resolved for experimental reasons (so-called gaps). However, if the dihedral angles were calculated between the two boundary amino acids of a gap at positions N and N+m (wherein m>1) this would obviously lead to wrong results. Therefore, it was necessary to unquestionably recognize and eliminate such gaps in protein structures. For this purpose, a geometric method was utilized:
The protein structure is defined primarily by the protein backbone. The spacing of the atoms involved in the peptide bond (N, CA, C, O) is largely constant due to the covalent nature of the bond. Between the two N-atoms they are in the range of two to five Å (Angstrom), the same applies to the other atoms (CA/CA, C/C, O/O).
Exceptions of this rule are found in turns in which the spacing can be larger for one to two pairs of atoms.
If variations can be measured for more than two pairs of atoms which do not fulfil the criteria cited above this will be recognized as a gap between these amino acids, i.e. no dihedral angles between these amino acids will be measured in the following.

The structural information for the given proteins was obtained from the current and commonly accessible protein data base (http://www.rcsb.org, state: Mar. 01, 2003).

A statistical analysis of the angle distribution for a distinct tetrapeptide first requires the non-redundancy of the data (protein chains) used from the given, highly redundant protein data base. This is often necessary in order to avoid a favoured weighting towards a particular topology. Other work often uses non-redundant data sets as a basis if similar problems are concerned; these non-redundant data sets are determined by alignments of the protein sequences against each other. However, in the present invention an almost complete (i.e., also partially redundant) protein data base was voluntarily used for the calculation of the dihedral angles. In this case, a redundant list of protein sequences is obtained for a particular tetrapeptide in which the dihedral angles for this tetrapeptide are listed. To (subsequently) clear this list from redundancy the protein sequences were then aligned against each other.

For this purpose, the algorithm according to Needleman-Wunsch was used which is applied to the determination of optimal, global alignments of two sequences (Needleman, S. B., Wunsch, C. D., J. Mol. Biol. (1970) 48:443-453). If the protein sequences are of different lengths or if the alignments overlap only at the ends global alignments result in errors in the evaluation since gaps at the beginning and the end of protein sequences are penalized. Such problems are encountered particularly if the sequence lengths differ from each other. For this reason, semi-global alignments were calculated, i.e. gaps at the beginning and the end of the sequence were not penalized. The gaps within a sequence were determined by the method according to Gotoh (affinic gap penalties, Gotoh, J. Mol. Biol. (1982) 162:705-708).

As a substitution matrix for the alignments the BLOSUM62 matrix (Pearson, Methods Enzymol. Vol. 266, S. 227-258, 1996) was chosen. The open penalty was set to a value of “−5” and the extension penalty to a value of “−2”. For the open penalty this corresponds to a value which is smaller by one as compared to the smallest value in the BLOSUM62 matrix. This prevents that a particular insertion/deletion (commonly referred to as InDel) is preferred to a substitution.

The principle for the determination of a non-redundant list of tetrapeptides including the respective conformations between amino acids 2 and 3 of the tetrapeptide on the basis of a given limiting value for the similarity of the two chains (sequence identity) can basically be described as follows:
1. The protein chains are sorted in a primary list according to length.
2. The longest protein is added to the list of results of the non-redundant proteins (sequence identity of the two chains less than or equal to 25%).
3. All shorter protein chains are sequentially aligned against the longest protein chain (against the protein chain added to the list of results in step 2). Those protein chains showing an identity to the longest protein of more than the set limiting value (e.g. 25% sequence identity) are removed from the primary list; otherwise, the respective protein remains in the primary list.
4. When the primary list has been completely worked off the longest protein is again removed from the primary list, added to the list of results, and afterwards step 3 is again performed.
5. When the primary list does no longer contain protein chains the list of results then contains those proteins with a sequence identity to each other that is smaller than the set limiting value.

The procedure described above increases the information content of the final probability density functions by approximately four-fold which effectively contributes to the quality of the probability density functions. In 146.300 probability density functions (146.300 observed tetrapeptides from the structural data base) calculated according to the present Example structural information from a total of 12.170 protein chains are stored.

However, if a data base of non-redundant protein structures was used as the primary data base (currently 3.002 proteins with a sequence identity of smaller than or equal to 25% assumed as the limiting value) a statistical analysis of the probability density functions would no longer be possible due to the low information content of the commonly non-redundant chains.

Thus, despite of the secondary redundancy of the 12.170 protein chains none of the resulting probability density functions does contain any redundant information. It has to be pointed out that the list of non-redundant proteins (3.002) is a complete subgroup of the 12.170 proteins which were eventually used.

From the data in the list of results (psi/phi angles for given tetrapeptides from non-redundant protein sequences) the probability density functions are calculated. In this respect, the frequently used programme “R” together with the so-called “sm” library (Adrian W. Bowman and Adelchi Azzalini, “Applied Smoothig Techniques for Data Analysis”, Oxford Statistical Science Series 18) was used in the present Example.

It is the principle of non-parametric kernel density estimation that first a point distribution without functional context is mathematically described (FIG. 2). In this method a distribution function (for example a Gauss function) is laid over each point of a point distribution and the overlapping areas of the distribution function are added. In this manner, a frequency distribution is obtained in which the individual points represent the values of the probability density function at a certain position. The probability density functions are subsequently standardized, i.e. for two-dimensional functions the area below the curve is equal to 1 while for three-dimensional functions the volume below the area is equal to 1.

An exemplary of a result of the calculated list of 146.300 tetrapeptides is the probability density function of the tetrapeptide EALC (shown in the one-letter code for amino acids; corresponding to the sequence glutamate, alanine, leucine, cysteine) shown in FIG. 3. The calculated angle distribution shows a clear preference for the angles psi=−40° and phi=−60. Practically no other angles are observed in the list of known protein structures although also other angles are allowed in the Ramachandran diagram for the amino acids mentioned.

### EXAMPLE 2

### Analysis and Optimisation of the Probability Density Functions

The dihedral angles obtained in Example 1 which describe a particular tetrapeptide are analysed by means of the non-parametric kernel density estimation. For this purpose, the analyses are conducted using the software package “R” and the related package “sm”. Package “sm” contains the respective functions which enable a probability density function analysis by means of the statistical programme “R”. The function and parameters used are listed below:

| | | |
|---|---|---|
| xlim | = cbind(−180, 180) | x axis represents the phi angle; ranging |
| | | from −180 to 180 |
| ylim | = cbind(−180, 180) | y axis represents the psi angle; ranging |
| | | from −180 to 180 |
| ngrid | = 91 | The coordinate system is divided into |
| | | 91 * 91 cells corresponding to scaling of the |
| | | axes in intervals of 4 angle degrees each |

The band width of the probability density function was first set to “default”. For this purpose, the band width is determined according to Sheather-Jones and used internally by the function. It was observed, however, that a manually determined band width is necessary; the standard band width interpolates the probability density functions too much. A default calculation results in an estimation of angle probabilities which would not be allowed according to the Ramachandran diagram. Therefore, band width analyses were carried out; first were employed band width values of 5 to 30 in intervals of 5 and the result of the functions was analysed. AWQC was used as a representative tetrapeptide for this purpose. Considering further that the psi angle has more freedom in the Ramachandran diagram than the phi angle, the values of 15 for phi and 25 for psi were determined as the optimal band widths.

Afterwards, the probability density functions of different tetrapeptides were compared to each other. In this respect, such pairs of tetrapeptides are of particular interest which differ from each other merely in a single substitution. According to the BLOSUM62 substitution matrix for example the substitution of glutamate (E) by lysine (K) in the tetrapeptide sequences ACNE and ACNK is evaluated with a value of +1, i.e. glutamate and lysine are largely treated as homologous amino acids. The probability density functions for the tetrapeptides ACNE and ACNK, however, show clearly different angle distributions. Consequently, a simple substitution of the two amino acids is not allowed. It can be recognized that the BLOSUM62 matrix (similar to all currently available substitution matrices) is of only limited usefulness for alignments.

Exemplarily, the following tetrapeptides were compared: ACNE, ACNK, and ACNG; as well as CIDV and CIDL.

FIG. 4 shows the diagrammatic result of the probability density functions for the tetrapeptides ACNE (FIG. 4a), ACNK (FIG. 4b), and ACNG chosen as examples. The four tetrapeptides differ only in the last amino acid, thus, at first the sequence difference in the fourth amino acid is out of the angle range of the second and third (considered) amino acid. Nevertheless, the fourth amino acid of the tetrapeptide has an essential influence on the density distribution of the phi/psi angles between the second and third amino acids. It shall be again pointed out with respect to this Example that a substitution of glutamate (E) by lysine (K) according to conventional evaluation schemes (e.g. the frequently used BLOSUM62 matrix) is explicitly allowed (value of “+1” in the substitution matrix). However, as can be seen from the probability density functions a substitution of this type can locally lead to an incorrect conformation which would globally result in an incorrect tertiary structure. The method of the present invention recognizes this situation and would circumvent this error in an alignment or in a validation. Similarly, this information can be utilized for the design of altered proteins (in the context of protein design).

By a comparison of the probability density functions with each other consensus sequences can be found which have always the same structure independent of the amino acid composition (and independent of the tertiary structure). This condition can be for example used in a de novo design of proteins wherein properties (for example binding affinities, solubilities, surface properties) of proteins can be altered in a targeted manner essentially without changing the tertiary structure of the protein backbone.

FIG. 5 shows the diagrammatic result of the probability density functions for the tetrapeptides CIDV (FIG. 5a) and CIDL (FIG. 5b) also chosen as examples. The four tetrapeptides again differ only in the last amino acid while the sequence difference of the fourth amino acid is out of the angle range of the second and third (considered) amino acids. Nevertheless, also in this tetrapeptide example mentioned the fourth amino acid has an essential influence on the density distribution of the psi/phi angles between the second and third amino acid. Although both substituted amino acids, leucine and valine, belong to the group of hydrophobic amino acids and substitutions of this type generally are considered as conservative, a conformational change of the underlying oligopeptide must be possibly expected in special cases described by the probability density functions.

The two Examples above show that the analysis of tetrapeptides used in the method described can lead to novel information which may provide valuable information for the conformational analysis as well as conformation modeling of proteins. Amino acids outside the mainly considered area of two amino acids can have a profound and significant influence on the formation of the angles between the two amino acids. Therefore, this information can be directly included into an alignment method as well as into a modeling method which should be superior to methods lacking this information. Furthermore, the tetrapeptide information may serve for the validation of given protein structures; those probability density functions having unequivocal preferences can be used for the evaluation of the conformation in modelled proteins. This case of an application is described in the following Example 3.

### EXAMPLE 3

### Validation of Protein Structures

The quality and utility of the probability density functions prepared according to Example 1 can be evaluated by evaluation studies. For this purpose, proteins are used which are derived from the commonly accessible protein data base (PDB; http://www.rcsb.org). In a first step of the evaluation two randomly selected, structurally simple proteins are used: bacterioferritin (PDB Code 1BCF, subunit Al) which mainly consists of alpha-helices, and UDP-N-acetylglucosamine acyltransferase (PDB Code 1 LXA) which predominantly consists of a beta-helix structure.

The principal procedure in the evaluation of protein structures by means of probability density functions is as follows:
The psi and phi angles of all tetrapeptides present in each protein are determined.
On the basis of the probability density functions the logarithmized probability density function values are determined using the determined pairs of psi/phi values.
The evaluation is determined from the difference of the maximum of the probability density functions and f(psi,phi).
The evaluations are plotted in a diagram for each amino acid position for each of the tetrapeptides.
It must be noted, that for the reason of a better visual representation in this Example all evaluations higher than or equal to 20 were set to a value of 20; values >20 are already so improbable that this simplification can be made.

The score values (DIFFMAX) for both proteins in the respective diagrams (FIGS. 6A and 6B) mostly are directly at the zero line. Thus, the local conformations observed in both proteins each correspond very well to the expected values of the probability density functions for the respective tetrapeptides. An angle variation from the expected angles would be manifested in a variation from the zero line; since this is a logarithmic plot of the variation the shown variations would be particularly significant.

Interesting are the DIFFMAX values in the diagram for the protein bacterioferritin (FIG. 6A) which differ from the zero line. For the tetrapeptides showing a conformational variation the positions in the protein were localized, and it was observed that these variations are exclusively localized in the loop regions of the protein. This shows that the probability density functions can recognize and determine very well the conformation of tetrapeptides in defined periodical secondary structures within the protein. However, in the loop regions of naturally occurring proteins they shows minor variations. This seems to be reasonable considering that the loops are undefined structural areas of a protein and thus have a higher conformational freedom than the periodical secondary structure elements.

Short segments with identical sequence can have different structures in different proteins. This fact could lead to the conclusion that an evaluation of the overall structure by means of probability density functions which are defined by oligopeptides would be impossible. The present invention, on the contrary, does not consider the geometric properties of a tetrapeptide separately but in the context of the adjacent tetrapeptides. Within a helix, a tetrapeptide able to bear both a helical and a β sheet conformation will attain the respective helical conformation although theoretically a β sheet conformation would be allowed. The calculated probability density functions are capable to recognize and cope with this situation with high reliability. Thus, this is not opposed to the earlier findings of Kabsch & Sander (Proc. Natl. Acad. Sci. U.S.A. Vol. 81, pp. 1075-1078, 1984) who found pentapeptides with the same sequence but with different conformations in proteins. In fact, such ambiguous assignments exist; however, a comprehensive structure determination provides such a high number of unequivocal assignments that again a statistically valid result regarding probable conformations in proteins can be obtained.

Furthermore, an artificial data set was generated containing proteins with a clearly incorrect folding, and these obviously incorrect structures were analysed by means of the probability density functions. As a result, low probabilities can be expected for the occurrence of the respective tetrapeptide conformations in incorrectly folded proteins.

The simulation of an incorrectly folded protein was performed—according to a procedure commonly used for this purpose—by exchanging the coordinates of the two proteins with each other (Novotny et al., Proteins, Vol. 4, pp. 19-30, 1988). Thus, the backbone structure of the A1 subunit of the protein bacterioferritin (PDB Code 1BCF) was transformed into that of UDP-N-acetylglucosamine acyltransferase (PDB Code 1LXA), and vice versa, i.e. the sequences were modelled in each case onto the other backbone. By each of these transformations misfolded proteins are obtained the folding topology of which is not compatible with the corresponding sequence. FIGS. 7A and 7B illustrate the result of the transformed proteins. The evaluation of the corresponding probability density functions shows that the preferred angles derived from the respective tetrapeptides are largely NOT realized in den structures; the angles realized in the structures show marked variations from the maximum values of the probability density functions (DIFFMAX) with respect to the tetrapeptides. In comparison to the original proteins (FIGS. 6A and 6B) the altered protein structures provide very unfavourable evaluations (improbable conformations) at many positions. This has shown that the calculated probability density functions are very well suited to distinguish correctly folded proteins (FIGS. 6A and 6B) from improperly folded proteins (FIGS. 7A and 7B) as a whole or in substructures (portions). Thus, the invention is very well suitable for the validation of a protein structure.

### EXAMPLE 4

### Analysis by Probability Density Functions without Tolerance of Angle Variations

Performing the analysis according to Example 3 for the protein human serum albumine (PDB Code 1AO6), subunit A1, already reveals unexpectedly high variations (large differences to the maximum of the probability density functions) in an analysis of the native structure. According to the interpretation in Example 3 this would mean that the native protein has a misfolded structure. For this reason, angle variation was allowed in the alignments in addition to the maximum sequence identity of 25%. This means that this protein will also be considered in the probability density function at an angle variation of >25° between two tetrapeptides although it shows a higher sequence identity (>25%) to the other proteins. It turns out that this procedure resulted in a marked improvement of the structure evaluation of human serum albumine (PDB Code 1AO6) while no parallel deterioration in the quality of the probability density functions was observed. The present Example 4 was selected to demonstrate this behaviour of the probability density functions.

From the non-redundant protein data base (3002 protein chains, ≦25% sequence identity of the chains among each other) test data sets were generated. For this purpose, the alphabetical ordered PDB identification codes were arranged randomly (random numerals according to http://www.random.org). From this randomized list ten proteins were again randomly selected (random numerals according to http://www.random.org).

The information with respect to the proteins chosen above (i.e. the dihedral angles) was cleared from the probability density functions describing those tetrapeptides from which the protein chains are built and the probability density functions were calculated anew (jackknifing test). In this manner, the probability density functions can be tested with simulated “novel” protein structures.

The results show that it is possible to evaluate unknown structures by the method described above. Ambiguous results are obtained only for a few unstructured regions; here, variations from the expected values of the probability density functions are obtained. This was expected, however. Errors are sometimes found also at the ends of periodical secondary structures; the reason for this is that the conformation of the peptide chain must sometimes attain a rather unusual conformation at this site for steric reasons.

The success of novel, reliable and automatable algorithms for the prediction of the tertiary structure is assessed in an international and public competition (Moult et al., Proteins: Struct. Funct. Genet. Suppl 3, 2-6, 1999). In this CASP competition (Critical Assessment of Techniques for Protein Structure Prediction, http://predictioncenter.llnl.gov/) research groups can file their suggestions regarding so far unknown protein structures for each of which the experimental determination is soon expected. After successful experimental structure elucidation the models filed until then are compared to the real structure; in this manner successful methods are objectively evaluated. To date, the CASP competition is acknowledged standard in the evaluation of novel modeling methods. Two proteins selected for prediction in the CASP competition of the year 2002 were also chosen for the analysis in this Example.

### EXAMPLE 5

### Preparation of Alignments

To assess the usefulness of the probability density functions as novel scoring functions for the application to alignments (cf. equations 5 to 12), δ5-3-ketosteroid isomerase (PDB Code 8CHO) was aligned against its own structure. The result is shown in FIG. 8. In this Example an open penalty of 7 and an extension penalty of 2 were employed. Equation 12 is used for the calculation of a matrix R which then in FIG. 8A is transformed into the accumulated probability density function values (without angle variation) which result from the Gotoh algorithm. The low accumulated probability density function values (red diagonal) demonstrate that the structure is very well recognized. FIG. 8B shows the same alignment of δ5-3-ketosteroid isomerase with probability density functions allowing an angle variation. No improvement of the alignment as compared to the evaluation without tolerance of angle variations can be observed. The reason for this is that this protein has a well defined structure.

FIG. 9 shows the sequence-structure alignment of ferrocytochrome C (PDB Code 1CYC) against its own structure (probability density functions without allowing angle variations). It can been seen from FIG. 9A that the structure is only poorly recognized. The reason for this is that the protein is practically devoid of structure as far as defined secondary structure portions (helices and β sheets) are concerned. FIG. 9B shows an identical alignment; but in this case the probability density functions allow for angle variation. It is remarkable how well the correct structure is recognized in the alignment in this case with the altered probability density functions.

In order to exclude that the probability density functions with angle variations loose sharpness, i.e., enable also certain conformations which are not allowed, δ5-3-ketosteroid isomerase was aligned against the unrelated ferrocytochrome C. It can be seen that both an alignment using probability density functions without angle variation (FIG. 10A) and also an alignment using probability density functions allowing for angle variations (FIG. 10B) do not result in a satisfactory alignment leading to the conclusion that the two sequences are not structurally related and that a plausible alignment between the two proteins cannot be prepared.

### EXAMPLE 6

### Analysis of the CASP 5 Proteins

In the CASP competition novel and so far unknown proteins and protein structures are used to assess the capabilities of novel methods for modeling of protein structures according to a generally acknowledged and independent procedure. Therefore, the CASP proteins are excellently suitable to test the probability density functions in a retrospective manner with respect to their ability to recognize and evaluate unknown structures. FIG. 11A and FIG. 11B show the alignments of the sequences (in each case with and without allowing angle variations of the probability density functions) of the ribosomal protein L30E (PDB Code 1H7M) against its structure—which was published after termination of the competition but not yet available in the data base underlying the calculations. It becomes clear that the structure which was unknown to the underlying probability density functions is well recognized and that the alignment is successful. The same is true for the sequence of the yajq protein (PDB Code 1lN0, FIGS. 12A and 12B). Also in this case the structure is very well recognized.

These Examples show that the present invention is very well suitable to assign the correct folding topology to sequences with unknown structures and also to discover errors in modelled structures. Furthermore, it has been demonstrated that so far unknown proteins can be successfully analysed and evaluated by means of the method.

### EXAMPLE 7

### Use of Pentapeptides for the Structure Validation of Proteins

The preceding Examples have demonstrated that if tetrapeptides (“1234”) are used in the underlying probability density functions the dihedral angles psi and phi between the amino acids 2 and 3 are dependent on the adjacent amino acids 1 and 4. By evaluating this information three-dimensional probability density functions could be calculated (dihedral angles are two-dimensional, the third dimension is the probability). The principle described can not only be used on tetrapeptides but also with oligomers of a different sequence length; this is demonstrated in the following using pentapeptides as an example. For pentapeptides (“12345”) the determination of the dihedral angles is performed between amino acids 2 and 3 as well as amino acids 3 and 4. The preparation of the required data base with pentapeptide structures is performed principally according to the description given in Example 1. The number of possible pentapeptides is calculated to 20⁵=3.200.000, in fact only 831.355 different pentapeptides can be detected in the currently available data base of protein structures.

The resulting probability density functions are five-dimensional, thus, a normal graphical representation is no longer possible. For a demonstration of the principle each five-dimensional probability density function can be simplified as two three-dimensional probability density functions (tetrapeptide “1234” and tetrapeptide “2345”). A determination of how much more improbable a conformation pair (dihedral angles 2-3 and 3-4) will be in comparison to the expected value of the five-dimensional probability density function can be achieved via mathematical AND linkage of the two three-dimensional probability density functions (the two three-dimensional probability density functions are not independent of each other). This gives:
σ=log(MAX(PDF₁₂₃₄)*MAX(PDF₂₃₄₅)−log(PDF₁₂₃₄(psi₂₃, phi₂₃)*PDF₂₃₄₅(psi₃₄, phi₃₄)
σ: provides how many orders of magnitude the measured conformation is more improbable than the most probable conformation
MAX: maximum of a probability density function
PDF₁₂₃₄: probability density function of the dihedral angles between amino acids 2 and 3 of the tetrapeptide 1234 wherein 1234 is part of the pentapeptide 12345
PDF₂₃₄₅: probability density function of the dihedral angles between amino acids 3 and 4 of the tetrapeptide 2345 wherein 2345 is part of the pentapeptide 12345
psi₂₃/psi₃₄: psi angle between amino acids 2 and 3 or 3 and 4, respectively, of the pentapeptide 12345
phi₂₃/phi₃₄: phi angle between amino acids 2 and 3 or 3 and 4, respectively, of the pentapeptide 12345
PDF₁₂₃₄(psi₁₂₃₄,phi₁₂₃₄): value of the probability density function PDF₁₂₃₄ for a particular pair of values (psi₁₂₃₄,phi₁₂₃₄)
PDF₂₃₄₅(psi₂₃₄₅,phi₂₃₄₅): value of the probability density function PDF₂₃₄₅ for a particular pair of values (psi₂₃₄₅,phi₂₃₄₅)

FIGS. 13A and 13B first show the probability density functions of the tetrapeptides ELRK and LRKA, respectively. It can be seen that in comparison to the allowed angles in the Ramachandran diagram both tetrapeptides can attain only very few different conformations and are therefore functions with high stringency. FIGS. 13C and 13D show the two three-dimensional probability density functions ELRK and LRKA which can be derived from the pentapeptide ELRKA. Again, it can be clearly recognized that in comparison to the probability density functions illustrated in FIGS. 18 and 19 these two probability density functions have improved with respect to sharpness. In this respect, if the tetrapeptide ELRK is considered only one possible psi/phi angle conformation is obtained in FIG. 20. The same is true for the tetrapeptide LRKA. It can be directly seen from this Example that the dihedral angles are not formed completely independently from each other but that they can be correlated in the manner described by the probability density functions.

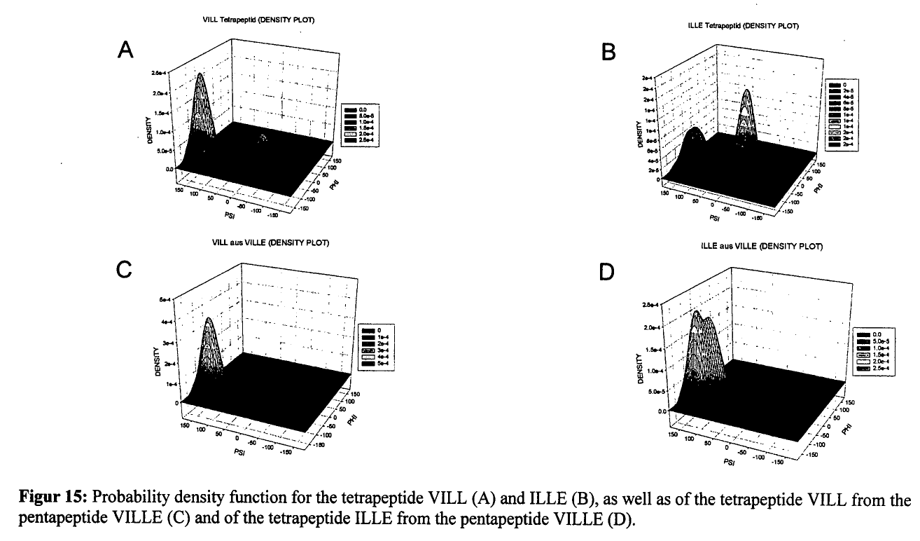

FIGS. 14A and 14B represent the probability density functions for the tetrapeptides GAKA and AKAG. Also in this case, only very few left possible angle conformations are observed in comparison to the Ramachandran diagram. FIGS. 14C and 14D show the corresponding tetrapeptides, GAKA and AKAG, which are part of the pentapeptide GAKAG. It is significant that in comparison to the probability density functions shown in FIGS. 22 and 23 the possible angle conformations are still further limited. Due to an AND linkage of the two probability density functions now only two possible conformations are left for each of the adjacent dihedral angles. In the specific case of GAKAG this means that only 150°, −80° (psi) for GAKA and 140°, −70° (phi) for AKAG or −40°, −60° (psi) for GAKA and −40°, −60° (phi) for AKAG are possible. Thus, an additional information gain has been achieved in comparison to the probability density functions of the tetrapeptides which may be used for example in structural modeling or the verification of structural information. FIG. 15 illustrates this situation again using the pentapeptide VILLE as an Example.

The Example shows that also with oligopeptides of a length different from four, in this case with oligopeptides having a length of five amino acids, the corresponding data bases and lists can be established by means of the mathematical methods described above and analysis and structure determination in the sense of the present invention can be performed based on this oligopeptide information. Basically, oligopeptides of all lengths from a sequence length of two amino acids or more can be used in the invention.

Therefore, knowing the method described above it is possible to definitely recognize and alter conformation patterns in proteins in an efficient manner. In addition, this offers novel possibilities in de novo design and point mutation of proteins.

What is claimed is:

1. A method for the validation of the conformation of given amino acid-based molecules comprising the following steps:
a) dividing the amino acid-based molecule into oligopeptides of the same length wherein the number of the oligopeptides is preferably defined by the formula:
n−(m−1)
wherein n is the number of amino acids in the amino acid-based molecule and m is the number of amino acids in the oligopeptide, and determining the psi and phi angles of these oligopeptides (observed value);
b) providing or preparing an oligopeptide data base which contains the values for the phi and psi angles for these oligopeptides;
c) determining the psi and phi angles for each of the oligopeptides determined in a) from the data base information (expected value);
d) subtracting the expected value from the observed value;
e) evaluation of the differences for each amino acid position wherein the smaller the difference between the expected value and the observed value is the higher is the probability of the accuracy of the given structure.

2. A method according to claim 1, wherein the expected value is the maximum of the probability density function of the psi and phi angles determined in c) and the observed value are the psi/phi-values observed for each oligopeptide in a).

3. A method according to claim 1 or 2, wherein in step c) the expected value is determined for oligopeptides in which one or more amino acids or sequence segments of a certain length are substituted compared to the oligopeptides present in the given amino acid-based molecule in the form of a similarity rule wherein the amount of the difference between observed value and expected value is a measure for the conformational change to be expected by the substitution.

4. A method for conformation determination starting from a linear amino acid sequence comprising the following steps:
a) dividing the amino acid sequence into oligopeptides of the same length wherein the number of the oligopeptides is defined by the formula:
n−(m−1)
wherein n is the number of amino acids in the amino acid-based molecule and m is die number of amino acids in the oligopeptide;
b) providing or preparing an oligopeptide data base which contains the values of the phi and psi angles for these oligopeptides;
c) determining the psi and phi angles for each oligopeptide determined in a) from the data base information wherein these angles are defined by the maximum of the probability density function of the psi and phi angels of each phi and psi angel provided in b);
d) generating the conformation of the amino acid sequence from the psi and phi angles determined in c) for each oligopeptide.

5. A method for the alignment of two or more amino acid sequences comprising the following steps:
a) providing an amino acid-based molecule having an unknown conformation and one or more template sequences;
b) dividing the two or more template sequences and the amino acid-based molecule having an unknown conformation into oligopeptides of the same length wherein the number of the oligopeptides is defined by the formula:
n−(m−1)
wherein n is the number of amino acids in the amino acid-based molecule and m is the number of amino acids in the oligopeptide,
c) determining the psi and phi angles of preferably all oligopeptides present in the template sequence(s);
d) providing or preparing an oligopeptide data base which contains the values of the phi and psi angles for the oligopeptides from b) and c);
e) alignment of the amino acid sequences on the basis of the comparison of the expected values of the psi and phi angles for the amino acid-based molecule having an unknown conformation and the observed psi and phi angles of the one or more template sequences.

6. A method according to claim 5, wherein the value of each psi and phi angle used in e) is defined by the maximum of the probability density function of the psi and phi angles of each phi and psi angle for these oligopeptides provided in d).

7. A method according to any of claim 1-6, wherein die oligopeptides each consist of five amino acids (pentapeptides).

8. A method according to claim 7, wherein the psi and phi angles between the second and third as well as the third and fourth amino acid of the pentapeptide are measured.

9. A method according to any of claim 1-6, wherein die oligopeptides each consist of four amino acids (tetrapeptides).

10. A method according to claim 9, wherein das protein consists of n amino acid residues and the number of he tetrapeptides is n−3.

11. A method according to claim 10, wherein die psi and phi angles between the second and third amino acid of the tetrapeptide are measured.

12. A method according to claim 1 or 2, wherein a given amino acid-based structure is evaluated with respect to particular properties by comparing the observed value and the expected value.
